(19) United States
(12) Patent Application Publication
(10) Pub. No.: US 2009/0144836 A1
(43) Pub. Date: Jun. 4, 2009

(54) DECODING/DECRYPTING BASED ON SECURITY SCORE

(75) Inventors: Srinivas Venkata Rama Gutta, Veldhoven (NL); Mauro Barbieri, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/719,404

(22) PCT Filed: Nov. 21, 2005
(86) PCT No.: PCT/IB2005/053847

§ 371 Date: May 16, 2007

Related U.S. Application Data
(60) Provisional application No. 60/630,670, filed on Nov. 24, 2004.

(51) Int. Cl. G06F 21/00

(52) U.S. Cl. 726/30

(57) ABSTRACT

A security system provides a security score (125) that corresponds to a likelihood that received content material (101) is authorized to be rendered, and controls (250) the rendering of the material based on the security score (125). The security score (125) can be compared (240) to a security criteria (151) that is associated with the material being rendered, so that different material impose different constraints. The security score (125) may also control (320) a level of quality/fidelity of the rendering of the material, so that, for example, a high-fidelity copy of the material is only provided when a high degree of confidence is established that providing a copy is authorized.

This invention relates to the field of electronic security systems, and in particular to a copy/playback protection system that controls a decoding or decryption process based on a security score determined by a receiver of the protected content material.

The need for protection systems to protect copyright material from illicit copying and distribution continues to increase. At the same time, dissatisfaction with the reliability of such protection systems has hampered the implementation of these systems.

Of particular concern is the problem of “false negatives”, wherein a protection system refuses to play an authorized copy of the content material. Consumers will be very dissatisfied with a product that refuses to play authorized material, and a vendor with a product that gains a reputation of preventing the play of authorized material is likely to lose substantial sales, including sales of future products. Similarly, a product that gains a reputation of taking a long time before allowing authorized material to be played will have an impact on a vendor's sales.

Conversely, the problem of “false positives”, wherein a protection system allows unauthorized material to play, impacts the sales of authorized content material, and a system that exhibits a high rate of false positives may not receive the endorsement of content providers.

Examples of common security techniques and examples of their limitations follow.

Watermarks are commonly used to protect content material. A watermark is designed such that its removal will adversely affect the quality of the protected material, yet its presence will not adversely affect the quality of the material. In most protection systems, the watermark contains information that must be decoded to determine whether the instant copy of the material is a valid copy. Because the watermark must be substantially ‘invisible’, the magnitude of the watermark signal must be substantially less than the magnitude of the material, and the decoding of the information contained within the watermark is subject to error, particularly when the processing of the material between the source of the material and the watermark detector introduces noise at or near the level of magnitude of the watermark signal.

To enhance the potential signal-to-noise ratio of a watermark signal, some protection systems substantially reduce the bandwidth of the watermark signal; however, such a reduction limits the amount of information that may be contained in the watermark and/or increases the time required to receive the watermark and determine whether the material is authorized. Alternatively, multiple watermarks may be encoded in the material, and authorization to access the material is based on a proportion of the watermarks that are successfully authenticated.

Biometric measures have also been proposed to control access to protected content material. Typically, a biometric feature is sensed or sampled by a sensing device and parameters associated with the sample are stored for comparison with parameters associated with other samples of the biometric feature. For ease of reference, the term biometric or biometric measure is used hereinafter to refer to the parameters associated with a sensed or sampled biometric feature. Thus, for example, the term ‘fingerprint’ includes whatever parameters are typically derived from an image of a person's finger tip.

In an example biometric security system, a purchaser's fingerprint is used to generate a key to encrypt content material when it is purchased. In such a system, the receiving device is configured to similarly generate a key to decrypt the content material based on the user's fingerprint. If the same finger is used to create the encryption key and the decryption key, then the encrypted material will be properly decrypted at the receiving device.

In another example biometric security system, a purchaser's fingerprint (or other biometric feature) is encoded into a watermark that is embedded in the purchased copy of the content material. The receiving system decodes the watermark and compares the purchaser's fingerprint with the user's fingerprint, and subsequently renders the protected material only if the fingerprints match.

It is well known, however, that biometrics change with time, and each reading of a biometric may differ based on the particular device used, the orientation of the biometric feature relative to the sensing device, the level of interference between the biometric feature and the sensing device, the clarity of the biometric feature, and so on. As is known in the art of criminal forensics, for example, the variance present in different instances of a person's fingerprint requires expert analysis to declare a match.

Other techniques are also available for controlling access to protected material, none of which have been shown to be infallible. Each known technique exhibits some likelihood of error having two components: a likelihood of false-positives (allowing unauthorized material to be presented) and a likelihood of false-negatives (preventing authorized material from being presented). The likelihood of error can be controlled by modifying parameters associated with the test (such as the aforementioned reduction in watermark bandwidth to increase the signal-to-noise ratio), but typically with adverse side-effects (such as the aforementioned longer watermark processing time and/or reduced watermark information content). Additionally, as is known in the art, a reduction of one error component (false-positive or false-negative) generally results in an increase in the other error component.

Given that all known security systems exhibit a likelihood of error, a need exists for controlling the impact of such errors.

It is an object of this invention to dynamically control the likelihood of false-negatives and false-positives. It is a further object of this invention to dynamically control the rendering of content material based on a measure of confidence that the material is authorized material. It is a further object of this invention to dynamically control the rendering of content material based on factors related to the material being rendered.

These objects, and others, are achieved by a method and system that provides a security score that corresponds to a likelihood that received content material is authorized to be rendered, and controls the rendering of the material based on the security score. The security score can be compared to a security criteria that is associated with the material being rendered, so that different material impose different constraints. The security score may also control a level of quality/fidelity of the rendering of the material, so that, for example, a high-fidelity copy of the material is only provided when a high degree of confidence is established that providing a copy is authorized.

The invention is explained in further detail, and by way of example, with reference to the accompanying drawings wherein:

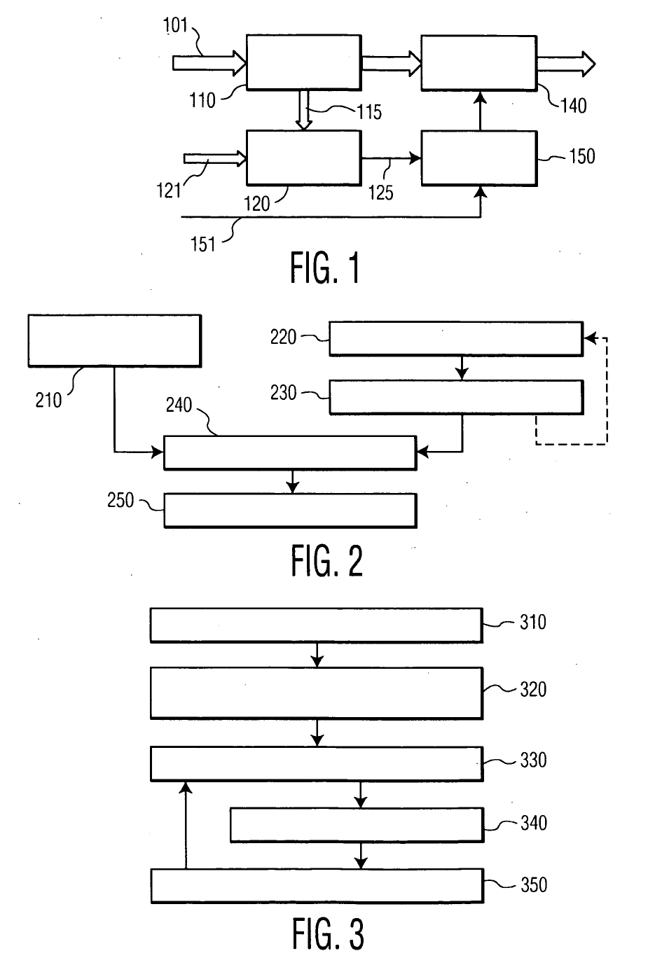

FIG. 1 illustrates an example block diagram of a security system in accordance with this invention.

FIG. 2 illustrates an example flow diagram of a security system that dynamically controls the rendering of protected content material in accordance with this invention.

FIG. 3 illustrates an example flow diagram of a security system that dynamically controls a level of quality of the rendering of protected content material in accordance with this invention.

Throughout the drawings, the same reference numeral refers to the same element, or an element that performs substantially the same function. The drawings are included for illustrative purposes and are not intended to limit the scope of the invention.

FIG. 1 illustrates an example block diagram of a security system in accordance with this invention. The security system includes a receiver 110 that receives protected content material 101, decoder 140 that transforms the protected material into a renderable form, a security evaluator 120 that determines a security measure 125 associated with the content material 101, and a security controller 150 that controls the decoder 140 based on the security measure 125.

The decoder 140 includes any of a variety of devices that are used to provide a controllable rendering of the material 101. In an embodiment using an encrypted form of the content material 101, for example, the decoder 140 includes a decrypter that is configured to decrypt the material based on information provided by the controller 150. In an alternative or supplemental embodiment, the decoder 140 may be configured to be enabled or disabled by the controller 150, or may be configured to provide varying degrees of output fidelity/quality based on a control signal from the controller 150, as discussed further below.

In the example of FIG. 1, the security evaluator 120 is configured to receive the security information 115 contained in the content material from the receiver 110, as would be used, for example, in a watermark-based security system. Additionally, the security evaluator 120 receives authentication information 121 that is used to verify the authorization of the content material 101 based on the security information 115. For example, a watermark that includes a serial number of an authorized disk may be embedded in the material 101. The receiver 110 is configured to provide this watermark to the security evaluator 120 as the security information 115, and the disk drive (not illustrated) that provides the content material 101 provides the serial number of the disk from which the material 101 was obtained, as the authentication information 121.

The security evaluator 120 applies the appropriate tests to determine whether the content material 101 is authorized/valid, using techniques common in the art. As contrast with conventional security systems, however, the security evaluator 120 of this invention provides a quantitative score 125, rather than a conventional binary pass/fail determination. For example, if the authentication is based on comparing serial numbers, the score 125 may be based on the number of matching bits of the serial numbers, recognizing that the decoding of a serial number from a watermark can be an error-prone process. In like manner, if the authentication is based on comparing biometrics, the score 125 may be a based on a degree of match between the biometrics, such as the number of matching feature-points in a pair of fingerprints.

Because of the aforementioned low signal-to-noise ratio typically associated with watermarks, and/or because of the aforementioned high variability of biometrics, protected content material 101 is often redundantly coded with the security information 115. Also, in a number of security systems, multiple, but not necessarily redundant, security identifiers are used, to provide a means for continually checking the validity of the material 101. In another example of providing a quantitative score, even if the particular test only provides a binary result, the security evaluator 120 can be configured to provide a security score 125 that is based on the proportion of tests that are passed or failed and/or based on an average score of a number of tests. These and other techniques for providing a security score based on security information associated with protected material will be evident to one of ordinary skill in the art in view of this disclosure.

In accordance with a first aspect of this invention, the security controller 150 uses the security score 125 from the security evaluator 120 and a security criteria 151 to control the decoder 140. This security criteria 151 can take on a variety of forms, as detailed further below, but a primary purpose of the criteria 151 is to allow the security controller 150 to dynamically control the decoder 140 based on information associated with the content material 101. For the purposes of this invention, the term dynamic control includes providing different control at different times. The different control may be applied while the same content material 101 is being processed, or may be applied to different instances of content material 101.

In a first example of a security criteria 151, the provider of the content material 101 may associate a minimum required security level to the content material 101, wherein the higher the level, the more stringent the control on the rendering of the material 101. If the security score 125 is above the minimum required security level, the security controller 150 allows the decoder 140 to continue the rendering of the content material 101; otherwise, the rendering is terminated.

If the security evaluator 120 is configured to provide an ongoing score associated with the material 101, based, for example, on repeated tests or continuing tests, the security controller 150 may be configured to terminate the rendering whenever the security score drops below the minimum level associated with this content material 101. Alternatively, the provider may associate a set of criteria 151 to the content material 101, such as an initial level required to start the rendering and a higher level required to continue beyond a certain point. In this manner, the delay time in commencing the rendering of the material can be reduced, while still assuring a high level of security to render a substantial portion of the content material.

In yet another embodiment, formal statistical tests may be applied by the security controller 150, and the provider may associate pass/fail criteria, such as a required confidence level in the test result for terminating the rendering. In the case of multiple continuing evaluations by the security evaluator 120, the use of a sequential test, such as the Sequential Probability Ratio Test (SPRT), is particularly well suited for determining whether to allow the rendering, continue testing, or prevent the rendering.

Of particular note, in accordance with this invention, different criteria 151 can be associated with different content material 101. In this manner, the provider of the content material 101 can effectively control the aforementioned false-negative and false-positive error rates. If a provider considers the costs of illicit copying to outweigh the costs of potentially annoying customers with strict controls and potential false-negatives, the provider can set the security criteria 151 high. On the other hand, if the provider is concerned regarding gaining a reputation of selling difficult-to-play material 101, the provider may choose to lower the criteria 151 to reduce the likelihood of false-negatives, even though the likelihood of allowing the play of unauthorized material is increased.

By the use of this invention, the party most affected by the enforcement of copy rights is provided control of this enforcement, with its concomitant advantages and disadvantages, and the vendor of the playback equipment is relieved of the responsibility for determining an appropriate balance between false-negative and false-positive errors. Alternatively, if the providers are unwilling to accept this responsibility and set security criteria, the vendor of the equipment can use this capability to adjust the security level to achieve an acceptable degree of false-negatives based on actual field experience and user feedback. Similarly, assuming that different providers of content material 101 may exhibit different levels of reliability for security information 115, such as different levels of signal-to-noise ratio, the vendor of the rendering equipment can choose to enforce different levels of security based on the provider of the material 101, to avoid having deficiencies of the security information 115 being attributed to the vendor's rendering equipment.

Additionally, by the use of this invention, the provider of content information 101 is provided the capability to reduce the likelihood of preventing the rendering of authorized material as the expected losses from allowing the rendering of unauthorized material is reduced. For example, if illicit copies are available, the loss of revenue from the sales of authorized copies of a highly rated movie when the movie is first released for distribution can be substantial. On the other hand, the expected revenue a year or two after distribution is substantially less, and therefore the expected loss of revenue to illicit copies is corresponding less. In like manner, the expected revenue from a poorly-rated movie is substantially less than the expected revenue from a highly-rated movie, and thus the expected loss of revenue to illicit copies of poorly-rated movies will be substantially less than the loss to illicit copies of highly-rated movies. By the use of this invention, the provider of the content material 101 can modify the criteria 151 based on the expected loss of revenue for the particular content material 101. In like manner, in the event that providers of the material 101 do not provide the security criteria 151, the vendor of the receiving equipment can choose to implement different criteria 151 based on the timeliness of the material 101, the rating of the material 101, and so on.

Any of a variety of methods may be used to communicate the security criteria 151 to the security controller 150. In a straightforward embodiment, the security criteria 151 may be contained in the meta-information provided with content material 101. For example, the security criteria 151 may be included in the table of contents that is typically provided on CDs and DVDs, or in synopses provided in broadcast transmissions. In an alternative embodiment, the security criteria 151 may be obtained via an on-line connection to a web-site associated with the provider of the material 101, the vendor of the receiving equipment, or a third-party, such as an association of video or audio producers.

In the example scenario of a vendor-determined security criteria 151, or product-determined security criteria 151, the security criteria 151 may be based on the current date, and the security controller 150 is configured to control the decoder 140 based on a difference between the current date and a date associated with the content material 101, such as the copyright date found in the meta-data associated with the material 101. If, for example, the material 101 is less than a year old, the security controller 150 may be configured to prevent the rendering of the material 101 until a very high security score 125 is achieved. On the other hand, if the material 101 is ten years old, the controller 150 may allow the rendering of the material 101 even if the security score 125 is low. Similarly, the security controller 150 may include a memory that includes “popular” items, such as the names of currently popular actors and actresses, currently popular producers and directors, and so on. In such an embodiment, the security criteria 151 may be the meta-data associated with the material 101, and if the controller 150 detects a match between the meta-data and a “popular” item, a higher level of security score 125 will be required to permit the rendering of the material 101.

In another example embodiment, the security criteria 151 may be dependent upon the function provided by the decoder 140. That is, for example, the security criteria for producing a copy of the material 101 may be set substantially higher than the security criteria for merely playing back the material 101. In this manner, a user who uses the decoder 140 to play back the protected material 101 is less likely to be impacted by a false-negative determination than a user who uses the decoder 140 to produce copies of the material 101.

These and other methods of defining and determining security criteria 151 upon which to base a determination of rendering control based on a security score 125 will be evident to one or ordinary skill in the art in view of this disclosure.

FIG. 2 illustrates an example flow diagram of a security system that dynamically controls the rendering of protected content material in accordance with this invention, as may be used in the security system of FIG. 1.

At 210, the security criteria is determined, using for example one of the methods detailed above. Not illustrated, if the security criteria is nil, the controller 150 of FIG. 1 is configured to allow the unrestricted rendering of the content material 101, and the subsequently detailed process is avoided.

At 220, the content material is received, or, the next segment of the content material is received, from which security information is derived.

At 230, a security test/evaluation is performed, for example, as detailed above with regard to the evaluator 120 of FIG. 1, and a security score is determined. As illustrated by the dashed line from the block 230 of FIG. 2, the security test/evaluation may be continually repeated. A security score from block 230 may be provided continually, or after a particular criteria is met, such as the receipt and test of a minimum number of segments of the content material.

At 240, the output of the security test block 230 is evaluated relative to the security criteria determined at 210. Based on this evaluation, the decoding/decryption of the content material is controlled, at 250. This control may be a simple on/off control, or a variable control, as discussed further below.

In accordance with a second aspect of this invention, the security controller 150 and the decoder 140 are configured to provide for varying levels of quality/fidelity in the rendering of the content material 101. This aspect may be implemented in concert with, or independent of, the use of a controllable security criteria 151, discussed above.

Because a quantitative score 125 is provided by the security evaluator 120, the security controller 150 can be configured to provide varying degrees of control of the decoder 140.

In a straightforward embodiment of this aspect of the invention, the decoder 140 is configured to truncate the lower-order bits of the renderable version of the content material 101. The degree of truncation in this embodiment is determined by the security controller 150, based on the security score 125. Optionally, the security controller 150 determines the degree of truncation based on the security score 125 relative to the security criteria 151.

In a more complex embodiment, the controller 150 controls the level of decoding of the content material in a progressive decoder 140. As is known in the art, some encoding schemes encode or encrypt content material 101 in a hierarchical manner. At the top level of the hierarchy, only the most prominent features of the material are encoded. At each subsequent level of the hierarchy, additional levels of detail, or resolution, are encoded.

FIG. 3 illustrates an example flow diagram of a security system that dynamically controls a level of quality of the rendering of progressively encoded content material.

At 310, the number of encoding levels is determined, typically from “header” information associated with the content material. At 320, the number of decoding levels is determined, based on the number of encoding levels and the security score determined for the current content material, optionally adjusted based on the security criteria. For example, a high security score relative to the security criteria will result in the number of decode levels being set equal to the number of encode levels. On the other hand, a low security score relative to the security criteria will result in fewer decode levels than encode levels.

The loop 330-350 progressively decodes, at 340, each of the encoded levels, up to the determined number of decode levels based on the security score associated with the current content material.

By controlling the quality of the rendering of the content material, the content provider or the equipment vendor can reduce the dissatisfaction that a user of authorized content material may experience due to overly restrictive security constraints by allowing a rendering of suspiciously illicit material, albeit at a lower quality level.

In like manner, by controlling the quality of the rendering based on the measure of security associated with the content material, the proliferation of illicit copies can be reduced. For example, if it assumed that an illicit copy of content material will generally exhibit a lower security score, each subsequent copy will have less than maximum quality, and their market value will be reduced.

Similarly, the quality of the rendering may be controlled based on the intended use of the rendering. That is, for example, the determination of the number of decode levels, or the determination of the number of truncated bits may be dependent upon whether the rendering is being performed to produce a copy of the material or to merely play back the material.

The foregoing merely illustrates the principles of the invention. It will thus be appreciated that those skilled in the art will be able to devise various arrangements which, although not explicitly described or shown herein, embody the principles of the invention and are thus within the spirit and scope of the following claims.

In interpreting these claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) each of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise; and

h) no specific sequence of acts is intended to be required unless specifically indicated.

i) the term “plurality of” an element includes two or more of the claimed element, and does not imply any particular range of number of elements; that is, a plurality of elements can be as few as two elements.

1. A method of controlling a rendering of content material (101), comprising:
determining (230) a security score (125) associated with the content material (101),
determining (210) a security criteria (151) associated with the content material (101), and
controlling (250) the rendering of the content material (101) based on the security score (125) and the security criteria (151).

2. The method of claim 1, wherein
the security criteria (151) is based on at least one of:
an age of the content material (101),
a rating of the content material (101),
a person associated with the content material (101), and
a synopsis of the content material (101).

3. The method of claim 1, wherein
the security score (125) is based on a correspondence between security information (115) contained in the content material (101) and authentication information (121) associated with an authorized copy of the content material (101).

4. The method of claim 3, wherein
the authentication information (121) corresponds to a biometric.

5. The method of claim 3, wherein
the authentication information (121) corresponds to information associated with a media containing the content material (101).

6. The method of claim 1, wherein
controlling (250) the rendering includes controlling a quality of the rendering of the content material (101).

7. The method of claim 1, further including
determining (220-230) a subsequent security score (125) and
controlling the rendering based on the subsequent security score (125) and the security criteria (151).

8. The method of claim 1, wherein
the security criteria (151) is provided with the content material (101).

9. The method of claim 1, wherein
determining (210) the security criteria (151) includes determining an intended use of the rendering.

10. A method controlling a rendering of content material (101), comprising:
determining (230) a security score (125) associated with the content material (101), and
controlling (250) a quality of the rendering of the content material (101) based on the security score (125).

11. The method of claim 10, wherein
the security score (125) is based on a correspondence between security information (115) contained in the content material (101) and authentication information (121) associated with an authorized copy of the content material (101).

12. The method of claim 11, wherein
the authentication information (121) corresponds to a biometric.

13. The method of claim 11, wherein
the authentication information (121) corresponds to information associated with a media containing the content material (101).

14. The method of claim 10, further including
determining (220-230) a subsequent security score (125) and
controlling (250) the quality based on the subsequent security score (125).

15. The method of claim 10, wherein
controlling (250) the quality is further based on an intended use of the rendering.

16. The method of claim 10, wherein
controlling (250) the quality is further based on a security criteria (151) associated with the content material (101).

17. The method of claim 16, wherein
the security criteria (151) is based on at least one of:
an age of the content material (101),
a rating of the content material (101),
a person associated with the content material (101), and
a synopsis of the content material (101).

18. A system comprising:
a receiver (110) that is configured to receive content material (101),
a decoder (140) that is configured to decode the content material (101) to provide renderable content material;
a security evaluator (120), operably coupled to the receiver (110), that is configured to determine a security score (125) associated with the content material (101),
a security controller (150), operably coupled to the security evaluator (120), that is configured to:
receive a security criteria (151) associated with the content material (101), and
control the decoder (140) based on a comparison of the security score (125) and the security criteria (151).

19. The system of claim 18, wherein
the security criteria (151) is based on at least one of:
an age of the content material (101),
a rating of the content material (101),
a person associated with the content material (101), and
a synopsis of the content material (101).

20. The system of claim 18, wherein
the security evaluator (120) is configured to determine the security score (125) based on a correspondence between security information (115) contained in the content material (101) and authentication information (121) associated with an authorized copy of the content material (101).

21. The system of claim 18, wherein
the decoder (140) is controllable to vary a quality of the renderable content material, and
the security controller (150) is configured to control the quality at the decoder (140) based on the security score (125).

22. A system comprising:
a decoder (140) that is configured to receive content material (101) and provide renderable content material, and
a security controller (150) that is configured to determine a security score (125) associated with the content material (101),
wherein
the decoder (140) is controllable to vary a quality of the renderable content material, and
the security controller (150) is configured to control the quality at the decoder (140) based on the security score (125).

23. The system of claim 22, wherein
the quality of the renderable content material includes a resolution of the renderable content material.

24. The system of claim 22, wherein
the security evaluator (120) is configured to determine the security score (125) based on a correspondence between security information (115) contained in the content material (101) and authentication information (121) associated with an authorized copy of the content material (101).

25. The system of claim 22, wherein
the security controller (150) is further configured to control the quality at the decoder (140) based on a security criteria (151) associated with the content material (101).
